(19) United States
(12) Patent Application Publication
(10) Pub. No.: US 2007/0007776 A1
(43) Pub. Date: Jan. 11, 2007

(54) Anti-spin bolt seal

(76) Inventors: Wanda K. Beard, Angola, IN (US); David L. Gilbert, Fort Wayne, IN (US)

Correspondence Address: PILLSBURY WINTHROP SHAW PITTMAN, LLP, P.O. BOX 10500, MCLEAN, VA, 22102, US

(21) Appl. No.: 11/482,138

(22) Filed: Jul. 7, 2006

Related U.S. Application Data
(60) Provisional application No. 60/697,124, filed on Jul. 7, 2005.

(51) Int. Cl. E05B 39/02

(52) U.S. Cl. 292/327

(57) ABSTRACT

An anti-spin security seal includes a locking member having a locking end, and an end piece. The end piece includes a locking body and a cover element. The locking body receives the locking end of the locking member therein to substantially secure the end piece to the locking member. The cover element receives the locking body therein and substantially encases the locking body therein. The cover element is loosely positioned about the locking body so that, when the cover element is rotated about a longitudinal axis of the locking body, rotation of the cover element is not readily imparted to the locking body.

### REFERENCE TO RELATED APPLICATIONS

This application relies for priority on U.S. Provisional Patent Application Ser. No. 60/697,124, which was filed on Jul. 7, 2005, the content of which are incorporated herein in its

### FIELD OF THE INVENTION

The present invention relates to locking devices or security seals for locking or sealing items, such as cargo containers, tanker trucks, freight trucks, railroad freight cars, doors or the like. More particularly, the present invention relates to a locking device or a security seal having a rod or bolt type locking member that is insertable into a locking body through a locking clasp or similar structure to lock or seal the cargo container, tanker truck, freight truck, railroad freight car, door or the like.

### BACKGROUND OF THE INVENTION

It is known in the art to provide a locking device or security seal for locking or sealing an item, such as cargo containers, doors, tanker trucks, freight trucks, railroad freight cars or the like, in a closed or sealed state.

In one known variety, locking devices or security seals include one or more locking bodies that connect to an end of a rod to secure the rod through the sealed item.

In one conventional example, a bolt or rod may be inserted into a typical steel locking body and secured thereto via a locking ring within the body that engages a groove on the bolt or rod.

Although the ring substantially precludes pulling the locking body off of the rod, the body is free to rotate about the rod.

The ability to spin the locking body presents a difficulty with the security associated with these types of locking devices and security seals. Specifically, it has been discovered that a person may spin the locking body relative to the locking rod at a high rate of speed (such as via a power drill or the like). When the locking body is spun at a high rate of speed, the locking body and/or locking rod may be heated to such a degree that the lock mechanism may be weakened, thereby allowing for removal of the locking body from the locking rod. After a person has removed the locking body and accessed the cargo container or door, the locking body may be reattached to the rod in a manner providing little evidence of tampering with the locking device or security seal.

It should be noted at this point that the mere fact that a person may tamper with the locking device or security seal should not be lead those skilled in the art to conclude that such locking devices or security seals are inherently defective or undesirable. This is not the case. In the shipping industry, as with any industry, there are many levels of security required or desired by a shipper, depending upon the nature of the cargo being shipped and the manner in which the cargo is shipped.

With respect to the different levels of security, in instances where the cargo itself is such that it is unlikely for a person to want to foil the security device, the conventional locking device or security seal may be more than adequate to deter unlawful activity. In other instances, the shipment may be under significant surveillance from the departure point to the arrival location such that it would be unlikely for a person to have the opportunity to tamper with the locking device or security seal during transit. In this instance, a conventional locking device or security seal may provide more than adequate security.

As would be appreciated by those skilled in the art, there are circumstances where a shipper will require or desire increased security.

As a result, there has developed a need for a locking device or security seal that discourages a person from accessing or spinning the locking body, thereby discouraging a person from tampering with such a locking device or security seal.

In addition, it is desirable for locking devices and security seals to be constructed, in some instances, to incorporate features that permit a shipment recipient to determine readily if any tampering with the locking device or security seal has occurred during transit of the shipment.

Accordingly, there has developed a need for a locking device or security seal that incorporates tamper evident features.

### SUMMARY OF THE INVENTION

One aspect of the present invention, therefore, provides a construction for a locking device or security seal with a locking body that improves resistance to tampering.

Another aspect of the present invention provides a construction for a locking device or security seal that incorporates features providing evidence of tampering.

One further aspect of the present invention provides a locking device or security seal that has an anti-spin feature that limits or substantially precludes a user from spinning the locking body at a high speed about the locking bolt or rod.

In one contemplated embodiment, the security seal includes a cover element or assembly that is loosely fitted or positioned around a locking body so as to substantially encase the locking body. Being loosely fitted, the cover element limits a person's ability to spin or rotate the locking body relative to the locking member, since any rotation of the cover element is not readily or substantially imparted to the locking body.

According to one aspect of the present invention, an anti-spin security seal includes a locking member having a locking end, and an end piece. The end piece includes a locking body and a cover element. The locking body receives the locking end of the locking member therein to substantially secure the locking body at the locking member. The cover element receives the locking body therein and substantially encases the locking body. The cover element is loosely positioned about the locking body so that the cover element is rotatable about a longitudinal axis of the locking body and the locking end of the locking member, whereby rotation of the cover element about the locking member is not readily imparted to the locking body.

In association with one embodiment of the present invention, it is an aspect to provide that the cover element may comprise first and second cover portions that are joined together to substantially retain the locking body within the cover element.

In association with another embodiment, a further aspect of the present invention is to provide a construction where the locking body comprises first and second locking body portions loosely received within a cover element.

It is another aspect of the present invention to provide a locking body constructed such that tampering or attempted tempering are more readily made apparent or evident to the recipient.

In connection with this aspect of the present invention, the cover element may include one or more reduced wall thickness portions or frangible elements so that the cover element may readily break or fracture if a person attempts to tamper with the locking device.

These and other objects, advantages, purposes and features of the present invention will become apparent upon review of the following specification in conjunction with the drawings.

### BRIEF DESCRIPTION OF THE DRAWINGS

The embodiments of the present invention are illustrated in the drawings appended hereto, in which:

FIG. 1 is a side elevation of a security seal in accordance with the present invention, incorporating a first embodiment of a locking assembly;

FIG. 2 is a cross-sectional view of the first embodiment of the locking assembly of the security seal illustrated in FIG. 1, the view being taken along the line 2-2 in FIG. 1 and excluding the locking rod;

FIG. 3 is a cross-sectional view of the first embodiment of the locking assembly of the security seal illustrated in FIG. 1, the view being taken along the line 3-3 in FIG. 1 and excluding the locking rod;

FIG. 4A is an end view of a second embodiment of a locking assembly of the security seal of the present invention, illustrated without the locking rod;

FIG. 4B is a cross-sectional view of the second embodiment of the locking assembly illustrated in FIG. 4A, the view being taken along the line 4B-4B in FIG. 4A;

FIG. 5A is an end view of a third embodiment of a locking assembly of the security seal of the present invention, also illustrated without the locking rod;

FIG. 5B is a cross-sectional view of the third embodiment of the locking assembly illustrated in FIG. 5A, the view being taken along the line 5B-5B in FIG. 5A;

FIG. 6A is an end view of a fourth embodiment of a locking assembly of the security seal of the present invention, again shown without the locking rod;

FIG. 6B is a cross-sectional view of the fourth embodiment of the locking assembly illustrated in FIG. 6B, the view being taken along the line 6B-6B in FIG. 6A;

FIG. 7A is a cross-sectional view of a fifth embodiment of a locking assembly of the security seal of the present invention, without an illustration of the locking rod, the view being of the locking assembly in a first state during manufacture; and

FIG. 7B is a cross-sectional view of the fifth embodiment of the locking assembly illustrated in FIG. 7A, shown after assembly.

### DESCRIPTION OF SELECTED EMBODIMENTS

Various, selected embodiments of the present invention are described herein. The description of any one embodiment is not intended to exclude any other embodiment, as equivalents of the embodiments of the present invention will be readily appreciated by those skilled in the art. The present invention is intended, therefore, to encompass both the embodiments described and any equivalents thereto.

In addition, the terms “locking device” and “security seal” are used interchangeably throughout the discussion herein. As would be appreciated by those skilled in the art, the present invention does perform aspects of locking of a door, container, tanker truck, freight truck, railroad freight car or the like. The present invention also provides a security seal with respect to the same. To the extent that the two terms define the invention more broadly, this result is intended.

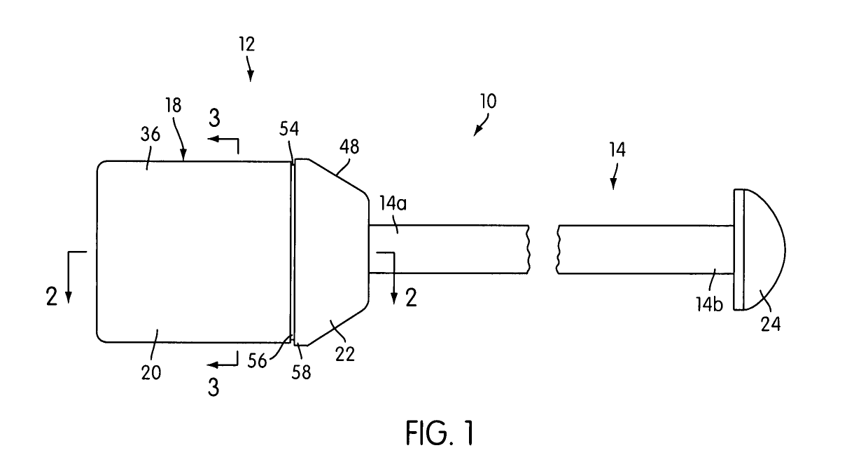

Referring to FIG. 1, a locking device or security seal 10 includes a locking assembly or end piece 12 that is attachable to a locking member, bolt, or rod 14. The end piece 12 receives a first end 14a of the rod 14 therein. To lock or seal a door, container, tanker truck, freight truck, railroad freight car or the like, the locking rod 14 is inserted through an object to lock (not illustrated), which may be a latch or similar structure, for example, on the door, container, truck, or car.

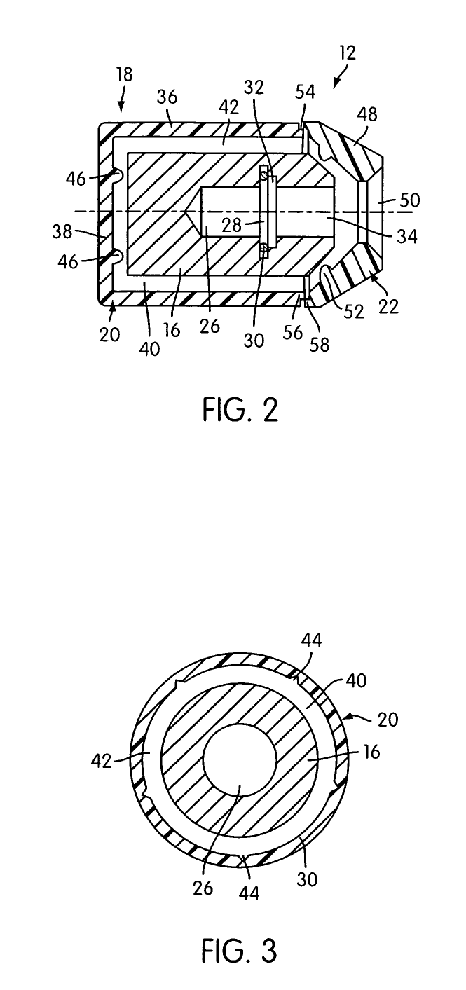

As illustrated in FIGS. 2 and 3, the end piece 12 includes a locking body 16 and a loosely fitting cover element or cover assembly 18. The cover assembly 18 may be a unitary cover or may include one or more separate portions that are assembled together, as discussed below.

In the first embodiment of the present invention, as shown in FIGS. 1-3, the cover assembly 18 includes a cover portion or cover 20 and a cap portion or cap 22. The cover assembly 18 is loosely fitted over and around the locking body 16 to limit or substantially preclude access to and movement of the locking body 16 relative to the locking rod 14, as also discussed below.

The locking member or rod 14 comprises a substantially rigid cylindrical rod formed of a metallic material, such as steel or the like (although the rod may be formed of other materials, without affecting the scope of the present invention). Although shown and described as a rigid cylindrical metallic rod, other types of locking members may be employed, such as a cable locking member with a rigid end portion that is received within the end piece 12, or other type of suitable locking member, without affecting the scope of the present invention.

In the illustrated embodiment, a second end 14b of the locking rod 14 may include a base or disc portion 24, which functions to engage a portion of a cargo container or door to limit or substantially preclude further insertion of the locking rid 14 through the container or door. Optionally, the second end 14b and the disc portion 24 may be received in a housing structure to increase the size of the second end 14b, as needed or desired. The housing structure that may be disposed around the second end 14b may include identifying indicia (such as a bar code, serial number, or other identifying features) for the security seal 10, for example. On example of such a housing or end piece may be found in PCT Application No. PCT/US2004/037838, filed Nov. 12, 2004, the content of which is incorporated herein by reference.

A first end 14a of the locking rod 14 may include a tapered, ramped, or conical end portion (not shown) with a narrowed section and a groove at or near the tapered end portion. The first end 14a, thus, is formed to be inserted into the end piece 12 and to be retained therein via a locking mechanism or element, as discussed below.

With reference to the first embodiment illustrated in FIGS. 1-3, the locking body 16 within the end piece 12 comprises a generally cylindrical body with a generally cylindrical bore or passageway 26 formed at least partially therein. The locking body 16 includes a ring retaining groove or enlarged portion 28 within the passageway 26 for receiving a locking element or locking ring 30 therein. As is known, the locking element or locking ring 30 may be a split or open ring or washer that is radially expandable but is biased toward its initial, radially-retracted orientation. The locking body 16, thus, may receive the second end 14a of the locking rod 14 therein to substantially secure the locking body 16 to the locking rod 14 via the locking ring 30.

The locking rod 14 and the locking body 16 cooperate as follows when the security seal 10 is attached to a door, container, truck, rail car, etc. As the tapered end 14a of the locking rod 14 is inserted into the passageway 26, the locking ring 30 slides along the ramped surface of the tapered end 14a of the locking rod 14 and expands until the locking ring 30 reaches the groove in the locking rod 14, whereupon the locking ring 30 contracts to its unexpanded or relaxed state. In its relaxed condition, the locking ring 30 engages the locking rod 14 rod at the groove to limit longitudinal movement of the locking rod 14 relative to the locking body 16. This operation may be appreciated by examining PCT Application No. PCT/US2004/037838, filed Nov. 12, 2004, the content of which is incorporated herein by reference.

The locking body 16 may further include a stepped or secondary passageway portion or second groove 32 disposed in the passageway 26 adjacent to the ring retaining groove 28. The second groove 32 has a reduced diameter relative to the ring retaining groove 28, but a larger diameter than that of the passageway 26. The locking body 16 further includes another stepped or reduced diameter passageway portion 34 adjacent to the second groove 32. The reduced diameter passageway portion 34, which forms part of the passageway 26, engages the locking ring 30 if the locking rod 14 is pulled outwardly relative to the locking body 16 after being inserted therein. As the locking rod 14 is pulled outwardly, the surface of the second groove 32 imparts a radially inward force on the locking ring 30 to cause the locking ring 30 to substantially engage or clamp against the locking rod 14, thereby enhancing the securement of the locking of the ring 30 to the locking rod 14 to retain the locking rod 14 within the locking body 16. Further outward movement of the locking rod 14 relative to the locking body 16 is substantially precluded by the narrowed diameter of the second groove 32 of locking body 16, since the diameter of the second groove 32 is less than the diameter of the locking ring 30 when the locking ring 30 is fully engaged against the locking rod 14. Accordingly, the locking ring 30 is not readily compressed further.

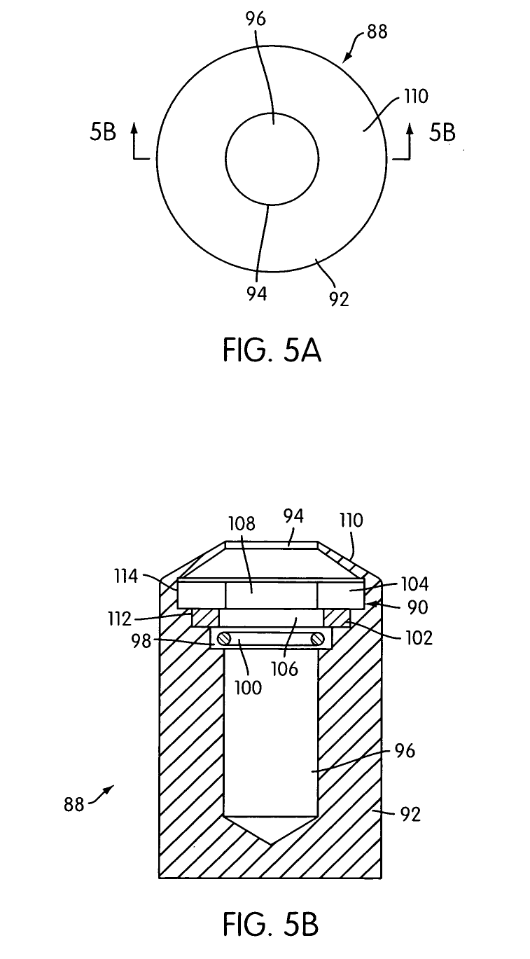

As illustrated in connection with the first embodiment of the invention in FIG. 2, the locking body 16 may have a unitary construction. The locking body 16 preferably is made from a metallic material, such as steel or the like, or it may comprise other suitable materials without affecting the scope of the present invention. The material from which the locking body 16 is made need not be a metallic material as would be appreciated by those skilled in the art. The locking body 16 may be made from a plastic, ceramic, or composite material without departing from the scope of the present invention. In addition, the locking body 16 alternatively may comprise two or more components or elements (such as the locking bodies 92, 120, and 136 of FIGS. 5A-B, 6A-B, and 7A-B, discussed below).

Although shown and described as being a generally cylindrical locking body, the locking body 16 may take any shape. Regardless of the shape, it is preferred that the locking body 16 be loosely received in the cover element 20 so that the cover element 20 may be rotated without also rotating the locking body 16. It is contemplated that any shape may be employed without departing from the scope of the present invention.

Also, although the locking body 16 is shown and described as having the ring retaining groove 28 formed therein, the cover element 18 may be formed to have the ring retaining element (as discussed below with respect to end pieces or locking assemblies 90 and 118 of FIGS. 5A-B and 6A-B), without limiting the scope of the present invention.

Returning to the discussion of the first embodiment of the present invention as illustrated in FIGS. 1-3, the end piece 12 includes the cover assembly 18, which is positioned around the locking body 16 and limits access to the locking body 16 so that a person may not readily tamper with locking body 16, such as by spinning the locking body 16 relative to the rod 14, as discussed. In the illustrated embodiment, the cover element 18 includes the cover 20 and the cap 22, both of which are loosely fitted around the locking body 16.

The cover portion 20 of the cover assembly 18 comprises a generally cylindrical member with a cylindrical outer wall 36 and an end wall 38, which define a receiving cavity 40 for receiving the locking body 16 therein. As shown in FIG. 2, the outer wall 30 is sized so as to loosely receive the locking body 16 therein, such that a void or space or gap 42 is defined between the outer wall 30 and the locking body 16.

Optionally, and with reference to FIG. 3, the outer wall 30 may include a plurality of internal fracture points or frangible portions 44, such as grooves or channels or narrowed thickness portions along the outer wall 36, in order to encourage breaking or fracturing of the cover 20, if a person attempts to squeeze the cover 20 onto the locking body 16 or if a person otherwise attempts to tamper with the security seal 10.

Optionally, the end wall 38 may include a plurality of raised portions or projections 46 protruding longitudinally toward the locking body 16. The projections 46 engage the end of the locking body 16 to space the end wall 38 from the locking body 16. The raised projections 46 reduce the contact area between the cover end wall 38 and the locking body 16 to reduce the frictional engagement or interference between the cover 20 and the locking body 16. Although shown and described as having a generally cylindrical form, the cover 20 may take any other shape without affecting the scope of the present invention.

The cap 22 is also loosely fitted over the locking body 16 and includes an outer conically-shaped body 48 that defines an opening 50 therethrough for receiving the locking rod 14 through the cap 22 when the locking rod 14 is inserted into the end piece 12 and into the locking body 16. Although shown and described as having an outer conically-shaped body 48, the cap 22 may take other shapes without affecting the scope of the present invention.

As illustrated in FIG. 2, the conically-shaped body 48 may include one or more raised projections or portions 52 extending radially inward to engage the locking body 16 and space the body 48 of the cap 22 and the cylindrical wall 36 from the locking body 16 when the locking body 16 is received within the cover assembly 18. Similar to the projections 46, the projections 52 function to reduce the contact area between the cap 22 and the locking body 16 so as to reduce the frictional engagement or interference between the cap 22 and the locking body 16.

The cap 22 and the cover 20 may be formed of a plastic or polymeric material or other substantially rigid material, such as metal or the like, and may be connected together to secure or retain the cover assembly 18 together around the locking body 16. Other materials also may be employed to construct the cover 20 and cap 22, such as ceramic or composite materials. The cap 22 and the cover 20 may be snapped together or may be otherwise retained together, such as via sonic welding or melting or the like, to define the cover assembly 18 around and substantially encasing the locking body 16. After the cover assembly 18 receives the locking body, the cap 22 is secured to the cover 20 to substantially encase the locking body 16 within the cap assembly 18 so that a person may not access the locking body 16 without breaking or otherwise tampering with the cap 22 and/or cover 20 of the cover assembly 18.

Optionally, the joint or connection 54 between the cover 20 and the cap 22 may be substantially thin and/or frangible so as to readily break apart if someone tampers with the cover 20 or the cap 22. This provides an additional tamper-evident feature for the security seal 10. In the illustrated embodiment, the cover 20 includes a notched or reduced diameter end or lip 56 that is partially received in or at a correspondingly formed lip 58 of the cap 22 when the cover 20 is assembled to the cap 22. When positioned adjacent to one another, the lips 48, 50 may be welded or melted of fused or otherwise joined together to substantially preclude detachment of the cover 20 from the cap 22 without breaking the joint 46 between the cover 20 and the cap 22 of the cover assembly 18.

According to the first embodiment, the rod 14 may be inserted through a locking hasp or element or the like of a cargo container or door or the like, and may be inserted into the locking body 16 to secure the security seal 10 to the door, container, tanker truck, freight truck, or railway freight car, for example. The locking ring 30 functions to substantially retain the locking body 16 relative to the locking rod 14 and to limit or substantially preclude longitudinal movement of the locking body 16 along the locking rod 14. The cover assembly 18 is loosely fitted or positioned around the locking body 16 so as to substantially encase the locking body 16. Because the cover assembly 18 substantially encases the locking body 16, a person cannot readily access the locking body 16 without tampering with or breaking or removing the cover assembly 18 from around the locking body 16. Also, because the cover element 18 is loosely fitted around the locking body 16, a person cannot readily spin or rotate the locking body 16 relative to the locking rod 14. Any rotation a person imparts to the cover assembly 18 will not be substantially translated to the locking body 16, since the cover assembly 18 may substantially freely rotate or spin about the locking body 16.

Also, if a person does attempt to access the locking body 16 or spin the cover assembly 18, the cover assembly 18 may readily break apart or fracture, either at the connection or joint 54 between the cover 20 and the cap 22 or at or along the frangible portions 44 at and/or along the cover 20, thereby providing a tamper evident feature for the security seal 10. Thus, if a person attempts to squeeze the cover 20 to engage the cover 20 with the locking body 16, the radial projections 52 of the cap 22 will limit radial inward compression of the substantially rigid cover 20. Application of a further compressive force will urge or squeeze the cover 20 against the locking body 16, resulting in a fracture of the connection joint 54 or of the frangible portions 44 of the cover element 20.

While the first embodiment of the present invention presents a construction with a cover assembly 18 having an end cap 22 and a cover portion 20, other multi-part constructions are also envisioned. For example, the cover assembly may be fashioned from two or more radial segments connected along seams longitudinally aligned with the axis of the locking bolt 14. Still further variations are contemplated, as would be appreciated by those skilled in the art.

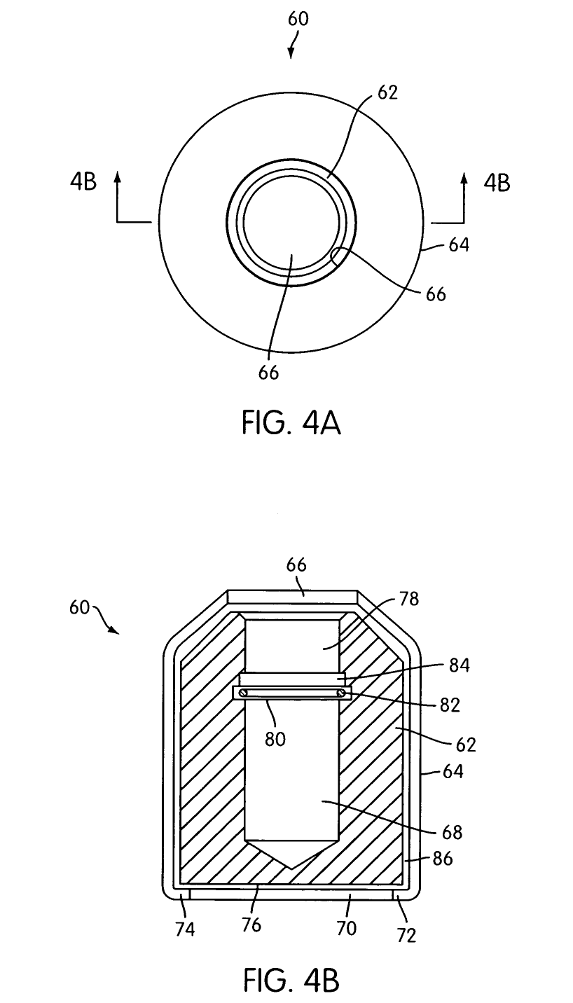

It is also contemplated that the cover assembly may be a unitary cover as illustrated in FIGS. 4A and 4B. The unitary cover receives the locking body 16 therein, as discussed in greater detail below.

With reference to FIGS. 4A and 4B, a locking assembly 60 for a security seal or locking device may include a locking body 62 and a unitary cover element 64 that loosely receives the locking body 62 therein and substantially encases the locking body 62 within the cover element 64. In this second embodiment of the present invention, the cover element 64 preferably is unitarily formed or molded of a polymeric or metallic material. Of course, as would be understood by those skilled in the art, other materials may be employed without departing from the scope of the present invention, as discussed in connection with the first embodiment.

The unitary cover element 64 defines a opening 66 therethrough, which generally aligns with a passageway 68 within the locking body 62 when the locking body 62 is received within the unitary cover element 64. The opposite end of the unitary cover element 64 may be partially or substantially closed over the end of the locking body 62. Whether partially or substantially enclosed over the end of the locking body 62, it is contemplated that the unitary cover element 64 may include an opening 70 at the bottom end 72 thereof.

In one contemplated variation of this second embodiment of the invention, the opening 70 may be large enough to allow for insertion of the locking body 62 into the unitary cover element 64 by press-fitting the locking body 62 therein. In another contemplated variation of this second embodiment of the invention, the unitary cover element is formed around the locking body 62. In either case, the unitary cover element 64, in its operational form, includes a circumferential lip 74 around the opening 70 that overlaps and covers at least a portion of an end surface 76 of the locking body 62. The circumferential lip 74 helps to retain the unitary cover element 64 over the locking body 62 and to limit access to the locking body 62.

In one contemplated variation of the second embodiment of the present invention, the unitary cover element 64 may be constructed from a flexible material such that the circumferential lip 74 deforms upon insertion of the locking body 62 therein. After the locking body 62 has been inserted into the unitary cover element 64, the circumferential lip 74 relaxes and returns to its initial state around and over the end of the locking body 62. As discussed in connection with the cover assembly 18, the unitary cover element 64 may be provided with reduced wall thickness portions (or grooves), thereby providing one or more frangible portions to provide a tamper evident function.

It is also contemplated that the circumferential lip 74 may extend substantially over the entirety of the end surface 76 of the locking body 62. With such a construction, access to the locking body 62 is substantially precluded. In this contemplated embodiment, the unitary cover element 64 may be formed as a generally cup-shaped element, permitting the locking body 62 to be readily inserted therein. It is contemplated that, after the locking body 62 is received in the unitary cover element 64, the end portion of the unitary cover element 64 would then be manipulated, such as by heating or some other treatment to deform the material. The heating or treatment of the unitary cover element 64 would result in closure of the open end (e.g., the end defining the opening 66) of the unitary cover element 64.

In addition, it is contemplated that the locking body 62 may be substantially similar to the locking body 16, discussed above. Accordingly, a detailed discussion of the locking body 62 will not be repeated. However, a general overview is provided. The locking body 62 includes a bore 78 that is aligned with the opening 66. The bore 78 includes a ring retaining groove 80 with a locking ring 82 disposed therein. One or more additional grooves 84 may also be provided, as discussed in connection with the locking body 16 in the first embodiment. The unitary cover element 64 surrounds the locking body 62 such that a gap 86 is defined therebetween, as in the first embodiment.

FIGS. 5A and 5B illustrate a third embodiment of the present invention. As shown, an end piece or locking assembly 88 for a security seal or locking device includes a locking body 90 and a unitary cover element 92 that loosely receives locking body 90 therein and substantially encases the locking body 90 within the unitary cover element 92. The unitary cover element 92 is formed or molded of a polymeric or metallic material and defines an opening 94, which generally aligns with the passageway 96 of the locking body 90 when the locking body 90 is received in the unitary cover element 92. The opposite end of the unitary cover element 92 may be partially, substantially, or completely closed.

The unitary cover element 92 includes a generally central passageway 96 and an enlarged diameter portion 98 for receiving the locking ring 100 therein. As discussed above, the diameter of the enlarged diameter portion 98 is greater than the diameter of the locking ring 100 when in its relaxed or contracted orientation. This allows for radial expansion or flexing of the locking ring 100 when the locking rod 14 is inserted into the passageway 96 of the locking body 90 and the unitary cover element 92.

In the embodiment illustrated in FIGS. 5A and 5B, the locking body 90 comprises multiple pieces. There is a first ring or portion 102 and a second ring or portion 104. The first ring 102 is a generally cylindrical ring with a first passageway 106 therethrough. The second ring 104 also is a generally cylindrical ring with a second passageway 108 therethrough. As can be seen in FIG. 5B, the diameter of the second passageway 108 is less than the diameter of the first passageway 106 so that second ring 104 defines a reduced diameter, or step, thereby enhancing engagement of the locking ring 100 with the locking rod 14.

The first and second rings 102, 104 may be inserted into and received in respectively formed cavities or passageway portions of the unitary cover element 92. The unitary cover element 92 includes a tapered end 110 that encases the first and second rings 102, 104 within the unitary cover element 92 and limits or substantially precludes removal of first and second rings 102, 104 therefrom.

It is contemplated that, in one variation, the unitary cover element 92 and the tapered end 110 may be made from a flexible material. As such, the tapered end portion 110 may be permitted to flex to allow for insertion of the first and second rings 102, 104 into the unitary cover element 92. After being inserted, the tapered end 110 of the unitary cover element 92 relaxes and returns to its initial state, thereby at least partially surrounding and covering the end of the locking body 90.

It is also contemplated that the unitary cover element 92 may be initially formed to be generally cup-shaped so that the first and second rings 102, 104 may be readily inserted into the open end of the unitary cover element 92. After the first and second rings 102, 104 are inserted into and loosely received in the unitary cover element 92, the end portion of the cover element may be heated or otherwise treated to bend the material and form the tapered end 110. The end portion of the unitary cover element 92 may be deformed in any of a number of suitable ways including heating, bending, shrinking, or otherwise forming the tapered end or lip 110 at the end of the unitary cover element 92. Once the tapered end 110 of the locking assembly 88 is formed, the first and second rings 102, 104 are retained therein.

In keeping with the anti-spin feature of the present invention, when the first and second rings 102, 104 are received within the passageway portions of the unitary cover element 92, the first and second rings 102, 104 are loosely retained within first and second grooves 112, 114 respectively. Being loosely retained in the first and second grooves 112, 114, the first and second rings 102, 104 may rotate therein such that rotation or movement of the cover element does not necessarily impart a corresponding rotation or movement of the locking body 90.

As with the prior embodiments, the unitary cover element 92 may be formed optionally with reduced wall thickness portions to establish frangible portions to provide a tamper evident function.

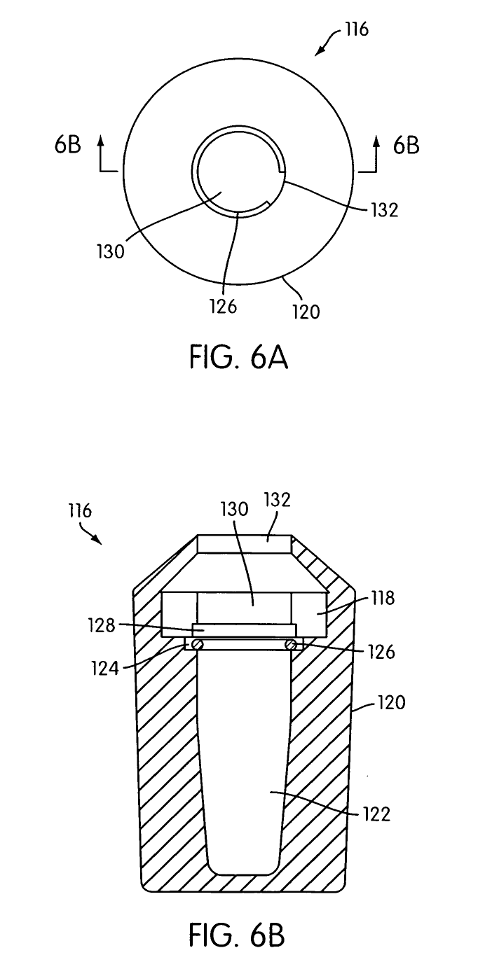

FIGS. 6A and 6B illustrate a fourth embodiment of the present invention. As shown, the locking assembly 116 includes a unitary locking body 118 received within a unitary cover element 120. The unitary cover element 120 defines a passageway 122 for receiving the end of the locking member or rod 14. The unitary cover element 120 also defines a groove 124 for receiving a locking ring 126 therein. The locking body 118 may be substantially similar to the locking body 90, discussed above, but with first and second stepped passageway portions 128, 130 formed or defined within the unitary cylindrical member or ring 118. The locking body 118 may be received and retained within the unitary cover element 120 in a similar manner as described above, such that the details of the end pieces need not be repeated. Optionally, the groove 124 may be formed within a third portion of the unitary locking body 118 or within a second or third locking body portion, without affecting the scope of the present invention. As before, the unitary cover element 120 defines an opening 132 therein for receipt of the tapered end of the locking rod 14.

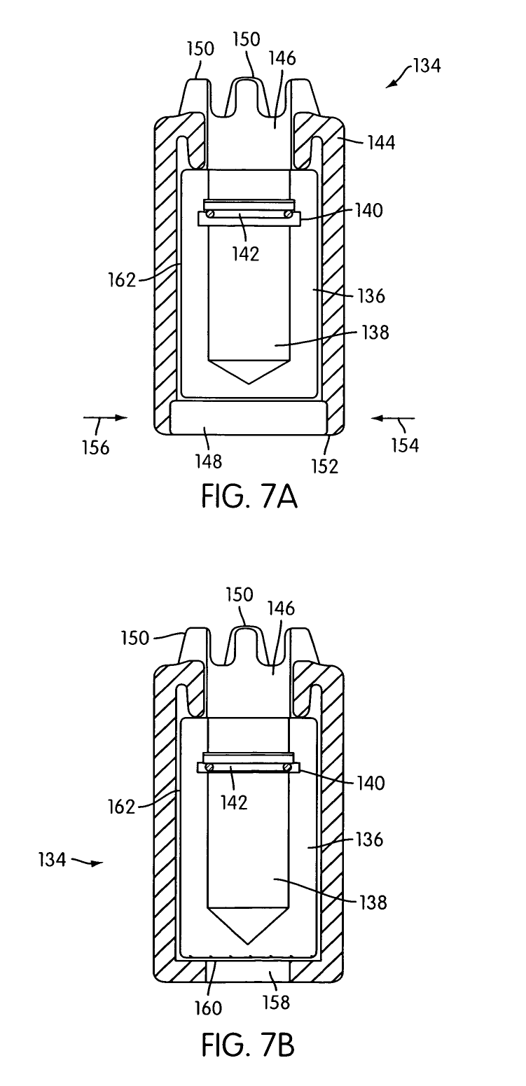

FIGS. 7A and 7B illustrate a fifth embodiment of the present invention. In these figures, a locking assembly 134 is illustrated. Here, a locking body 136, constructed similarly to the locking body 16, as illustrated in FIGS. 2 and 3, is employed, although other embodiments of the locking body may be employed as discussed above. The locking body 136 defines a central passageway 138 therein for receipt of the tapered end of the locking rod 14. The central passageway 138 defines a groove 140 in which a locking ring 142 is disposed. The locking assembly 134 also includes a cover element 144 defining an opening 146 at the top and an opening 148 at the bottom. The opening 146 at the top permits the tapered end of the locking rod 14 to be inserted into the locking assembly 134. The opening at the bottom permits placement of the locking body 136 therein from the bottom. Protrusions 150 are provided around the opening 146 at the top of the cover element 144 to facilitate lateral securement of the locking assembly 134 on the locking rod 14 and discourage tampering with the locking body 136.

To secure the locking body 136 within the cover element 144, the locking body 136 is inserted into the cover element 144 through the opening 148 at the bottom of the cover element 144. The cover element 144, which is provided with a circumferential lip 152, is then deformed, as indicated by arrows 154, 156, so that the circumferential lip 152 creates an opening 158 in the bottom of the cover element 144, exposing a portion of a bottom surface 160 of the locking body 136.

In summary, the present invention provides a locking device or security seal that has a loosely fitted cover that substantially encases a locking body or multiple locking body portions so as to limit or substantially preclude rotation of the locking body about the locking rod when the cover element is rotated. The cover element thus limits or substantially precludes someone from rotating the locking body about the locking rod at high speeds to allow the locking body to be removed from the locking rod. This is because the loose fitting cover element lacks the frictional engagement required to spin the locking body and lock mechanism and, thus, the level of heat required to defeat the lock mechanism of the security seal cannot be attained. Also, the cover element may readily break or fracture at one or more fracture points or frangible portions to provide a tamper evident feature that shows that the security seal was tampered with. For example, the cover may break at one or more fracture points or areas and/or the joint between the cover and cap may break or fracture if the cover element and security seal are tampered with.

Changes and modifications to the specifically described embodiments may be carried out without departing from the principles of the present invention, which is intended to be limited only by the scope of the appended claims as interpreted according to the principles of patent law.

What is claimed is:

1. An anti-spin security seal, comprising;
a locking member having a locking end defining a longitudinal axis and a circumferential grove therein; and
an end piece engageable with the locking end of the locking member, the end piece comprising
a cover element,
a locking body substantially encased by the cover element and loosely positioned within the cover element, such that rotation of the cover element about the longitudinal axis of the locking member is not readily imparted to the locking body, and
a locking ring disposed within the cover element and being cooperable with the locking body and the circumferential groove at the locking end of the locking member to secure the end piece to the locking member by discouraging removal of the end piece from the locking member after the locking end lockably engages the end piece.

2. The anti-spin security seal of claim 1, wherein the locking member comprises a substantially rigid rod.

3. The anti-spin security seal of claim 1, wherein the cover element comprises one or more protrusions on an interior surface to minimize engagement between the cover element and the locking body, thereby discouraging rotation of the locking body upon rotation of the cover element.

4. The anti-spin security seal of claim 1, wherein the cover element comprises:
a unitary body portion defining at least one opening therethrough so that the locking end of the locking member may be inserted therethrough to engage the locking ring.

5. The anti-spin security seal of claim 1, wherein the cover element comprises:
at least first and second portions joined together along a joint to substantially encase the locking body and locking ring therein.

6. The anti-spin security seal of claim 5, wherein the cover element comprises:
a cover; and
a cap joined to the cover along the joint,
wherein the cover defines an opening so that the locking end of the locking member may be inserted therethrough to engage the locking ring.

7. The anti-spin security seal of claim 5, wherein the joint is frangible.

8. The anti-spin security seal of claim 5, wherein at least one of the first and second portions includes at least one frangible portion that is easily fractured if tampering with the cover element occurs.

9. The anti-spin security seal of claim 8, wherein at least one frangible portion comprises a portion of the cover element where a wall thickness is reduced comparatively to a non-frangible portion of the cover, the reduced wall thickness permitting the cover element to fraction if tampering occurs.

10. The anti-spin security seal of claim 1, wherein the locking body comprises:
a locking ring defining a passageway therethrough to permit the locking end of the locking member to be inserted therein and a groove, with a diameter smaller than an outer diameter of the locking ring in a relaxed condition, the locking ring being disposed adjacent to the groove.

11. The anti-spin security seal of claim 1, wherein the locking body comprises:
a first ring disposed adjacent to the locking ring, wherein an inner diameter of the first ring is smaller than an outer diameter of the locking ring when in a relaxed condition, the rocking ring being disposed adjacent to a first side of the first ring; and
a second ring being disposed adjacent to a second side of the first ring, the second ring having an inner diameter smaller than the inner diameter of the first ring.

12. The anti-spin security seal of claim 1, wherein the locking body comprises a body defining a central passageway permitting the locking end of the locking member to be inserted therein, a first groove with a diameter greater than an outer diameter of the locking ring in an expanded condition, the locking ring being disposed in the first groove, and at least one second groove, adjacent to the first groove, with a diameter smaller than an outer diameter of the locking ring in a compressed condition.

13. The anti-spin security seal of claim 10, wherein the cover element defines a central passageway into which the locking end of the locking member is insertable, a first groove with an inner diameter greater than an outer diameter of the locking ring in an expanded condition, the locking ring being disposed in the first groove when in a relaxed condition, and a second groove in which the locking body is loosely positioned.

14. The anti-spin security seal of claim 11, wherein the cover element defines a central passageway into which the locking end of the locking member is insertable, a first groove with an inner diameter greater than an outer diameter of the locking ring in an expanded condition, the locking ring being disposed in the first groove when in a relaxed condition, a second groove, adjacent to the first groove, in which the first ring of the locking body is disposed, and a third groove, adjacent to the second groove, in which the second ring of the locking body is disposed.

15. The anti-spin security seal of claim 12, wherein the cover element comprises a unitary body substantially surrounding the locking body, the unitary body defining a circumferential lip that covers at least a portion of a bottom end of the locking body.

16. The anti-spin security seal of claim 12, wherein the cover element further comprises one or more protrusions extending exteriorly therefrom, positioned around the opening thereof, extending along the longitudinal axis of the locking member when inserted into the end piece.

17. The anti-spin security seal of claim 1, wherein the locking body comprises metal.

18. The anti-spin security seal of claim 1, wherein the cover element comprises plastic.

19. The anti-spin security seal of claim 1, wherein the locking ring comprises metal.

20. The anti-spin security seal of claim 1, wherein the cover element comprises metal.
